(19) United States
(12) Patent Application Publication
(10) Pub. No.: US 2013/0309550 A1
(43) Pub. Date: Nov. 21, 2013

(54) LEAD-ACID BATTERY WITH HIGH POWER DENSITY AND ENERGY DENSITY

(71) Applicants: Subhash Dhar, Bloomfield Hills, MI (US); Fabio Albano, Royal Oak, MI (US); Srinivasan Venkatesan, Bloomfield Hills, MI (US); William Koetting, Davisburg, MI (US); Franklin Martin, Rochester, MI (US); Lin Higley, Troy, MI (US)

(72) Inventors: Subhash Dhar, Bloomfield Hills, MI (US); Fabio Albano, Royal Oak, MI (US); Srinivasan Venkatesan, Bloomfield Hills, MI (US); William Koetting, Davisburg, MI (US); Franklin Martin, Rochester, MI (US); Lin Higley, Troy, MI (US)

(73) Assignee: Energy Power Systems LLC.

(21) Appl. No.: 13/475,484

(22) Filed: May 18, 2012

(51) Int. Cl. H01M 10/12; H01M 10/16; H01M 2/20; H01M 10/18; H01M 2/02

(52) U.S. Cl. 429/149; 429/122; 429/210; 429/158; 429/211

(57) ABSTRACT

A battery module for an electric vehicle or a hybrid electric vehicle having two or more battery components. An lead-acid electrochemical storage device is provided, comprising a specific power of between about 550 and about 1,900 Watts/kilogram; and a specific energy of between about 25 and about 80 Watt-hours/kilogram.

### RELATED APPLICATIONS

This application incorporates by reference the entire disclosure of U.S. application Ser. No. 13/350,505, entitled, “Improved Substrate for Electrode of Electrochemical Cell,” filed Jan. 13, 2012, by Subhash Dhar, et al., and the entire disclosure of U.S. application Ser. No. 13/350,686, entitled, “Lead-Acid Battery Design Having Versatile Form Factor,” filed Jan. 13, 2012, by Subhash Dhar, et al.

### TECHNICAL FIELD

Embodiments of the present disclosure relate generally to improved electrochemical cells, batteries, modules, and battery systems for electric and hybrid-electric vehicles. More particularly, embodiments of the present disclosure relate to lead-acid electrochemical cells, batteries, modules, and systems having improved specific power and/or specific energy.

### BACKGROUND

Lead-acid electrochemical cells have been commercially successful as power cells for over one hundred years. For example, lead-acid batteries are widely used for starting, lighting, and ignition (SLI) applications in the automotive industry.

As an alternative to lead-acid batteries, nickel-metal hydride (“Ni-MH”) and lithium-ion (“Li-ion”) batteries have been used for electric and hybrid-electric vehicle applications. Despite their higher cost, Ni-MH and Li-ion electro-chemistries have been favored over lead-acid electrochemistry for electric and hybrid-electric vehicle applications due to their higher specific energy and energy density compared to prior known lead-acid batteries.

While lead-acid, Ni-MH, and Li-ion batteries have each experienced commercial success, conventionally, each of these three types of chemistries have been limited to certain applications. FIG. 1 shows a Ragone plot, as adapted from, E. J. Cairns, P. Albertus, Rev. Chem. Biomol Eng. 1, pp. 299-320, (2010). FIG. 1 shows various types of electrochemical cells that have been used in automotive applications, depicting their respective specific powers and specific energies compared to other technologies.

In addition to the differing uses of lead-acid, Ni-MH and Li-ion batteries, the specific energy, energy density, specific power, and power density of these three electro-chemistries vary substantially. Typical values for systems used in hybrid-electric vehicle (HEV)-type applications are provided in Table 1 below.

TABLE 1

| Electro-chemistry | Specific Energy | | Volumetric Energy | | Specific Power | |
|---|---|---|---|---|---|---|
| Type | Density (Whr/kg) | | Density (Whr/l) | | Density (W/kg) | |
| Lead-Acid¹ | 30-50 | Whr/kg | 60-75 | Whr/l | 100-250 | W/kg |
| Nickel Metal | 65-100 | Whr/kg | 150-250 | Whr/l | 250-550 | W/kg |
| Hydride (Ni-MH)² | | | | | | |
| Lithium-Ion | up to 131 | Whr/kg | 250 | Whr/l | up to 2,400 | W/kg |
| (Li-ion)³ | | | | | | |

See, e.g., Reddy, Thomas D., ed., Linden's Handbook of Batteries, at 29-30, McGraw-Hill, New York, New York (4th ed. 2011).

Lead-acid battery technology is low-cost, reliable, and relatively safe. Certain applications, such as complete or partial electrification of vehicles and back-up power applications, require higher specific energy than traditional SLI (Starting-Lighting-Ignition) lead-acid batteries deliver.

As shown in Table 1, conventional lead-acid batteries suffer from low specific energy due to the weight of the components. Thus, there remains a need for low-cost, reliable, and relatively safe electrochemical cells for various applications that require high specific energy and/or high specific power, including certain automotive and back-up power applications.

Lead-acid batteries, nevertheless, have many advantages. First, they are a low-cost technology capable of being manufactured anywhere in the world. Accordingly, production of lead-acid batteries readily can be scaled-up. Lead-acid batteries are available in large quantities in a variety of sizes and designs. In addition, they deliver good high-rate performance and moderately good low- and high-temperature performance. Lead-acid batteries are electrically efficient, with a turnaround efficiency of 75 to 80%, provide good “float” service (where the charge is maintained near the full-charge level by trickle-charging), and exhibit good charge retention. Further, although lead is toxic, lead-acid battery components are easily recycled. An extremely high percentage of lead-acid battery components (in excess of 95%) are typically recycled.

Lead-acid batteries suffer from certain disadvantages as well. They offer relatively low cycle life, particularly in deep-discharge applications. Due to the weight of the lead components and other structural components needed to reinforce the plates, lead-acid batteries typically have limited energy density. If lead-acid batteries are stored for prolonged periods in a discharged condition, sulfation of the electrodes can occur, damaging the battery and impairing its performance. In addition, hydrogen can be evolved in some designs.

In contrast to lead-acid batteries, Ni-MH batteries use a metal hydride as the active negative material along with a conventional positive electrode such as nickel hydroxide. Ni-MH batteries feature relatively long cycle life, especially at a relatively low depth of discharge. The specific energy and energy density of Ni-MH batteries are higher than for lead-acid batteries. In addition, Ni-MH batteries are manufactured in small prismatic and cylindrical cells for a variety of applications and have been employed extensively in hybrid electric vehicles. Larger size Ni-MH cells have found limited use in electric vehicles.

The primary disadvantage of Ni-MH electrochemical cells is their high cost. Li-ion batteries share this disadvantage. Yet, improvements in energy density and specific energy of Li-ion designs have outpaced advances in Ni-MH designs in recent years. Thus, although nickel metal hydride batteries currently deliver substantially more power than designs of a decade ago, the progress of Li-ion batteries, in addition to their inherently higher operating voltage, has made them technically more competitive for many electric and hybrid-electric vehicle applications that might otherwise have employed Ni-MH batteries.

Li-ion batteries have captured a substantial share not only of the secondary consumer battery market but a major share of OEM (Original Equipment Manufacturer) hybrid battery, vehicle, and electric vehicle applications as well. Li-ion batteries provide high-energy density and high specific energy, as well as long cycle life. For example, Li-ion batteries can deliver greater than 1,000 cycles at 80% depth of discharge.

Li-ion batteries have certain advantages. They are available in a wide variety of shapes and sizes, and are much lighter than other secondary batteries that have a comparable energy capacity (both specific energy and energy density). In addition, they have higher open circuit voltage (typically ˜3.5 V vs. 2 V for lead-acid cells). In contrast to Ni—Cd and, to a lesser extent, Ni-MH batteries, Li-ion batteries suffer no “memory effect,” and have much lower rates of self discharge (approximately 5% per month) compared to Ni-MH batteries (up to 20% per month).

Li-ion batteries, however, have certain disadvantages as well. They are expensive. Rates of charge and discharge above 1C at lower temperatures are challenging because lithium diffusion is slow and it does not allow for the ions to move fast enough. Further, using liquid electrolytes to allow for faster diffusion rates, results in formation of dendritic deposits at the negative electrode, causing hard shorts and resulting in potentially dangerous conditions. Liquid electrolytes also form deposits (referred to as an SEI layer) at the electrolyte/electrode interface, that can inhibit electron transfer, indirectly causing the cell's rate capability and capacity to diminish over time. These problems can be exacerbated by high-charging levels and elevated temperatures. Li-ion cells may irreversibly lose capacity if operated in a float condition. Poor cooling and increased internal resistance cause temperatures to increase inside the cell, further degrading battery life. Most important, however, Li-ion batteries may suffer thermal runaway, if overheated, overcharged, or over-discharged. This can lead to cell rupture, exposing the active material to the atmosphere. In extreme cases, this can cause the battery to catch fire. Deep discharge may short-circuit the Li-ion cell, causing recharging to be unsafe.

To manage these risks, Li-ion batteries are typically manufactured with expensive and complex power and thermal management systems. In a typical Li-ion application for a hybrid vehicle, two-thirds of the volume of the battery module may be given over to collateral equipment for thermal management and power electronics and battery management, dramatically increasing the overall size and weight of the battery system, as well as its cost.

Although both Ni-MH and Li-ion battery chemistries have claimed a substantial role in hybrid and electrical vehicles, both chemistries are substantially more expensive than lead-acid batteries for vehicular propulsion-assist. The present inventors believe that the embodiments of the present disclosure can substantially improve the capacity of lead-acid batteries to provide a viable, low-cost alternative to Ni-MH and Li-ion electro-chemistries in all types of electric and hybrid-electric vehicle applications.

In particular, certain applications have proved difficult for Ni-MH and Li-ion batteries, such as certain automotive and standby power applications. Standby power application requirements have gradually been raised. The standby batteries of today have to be truly maintenance free, have to be low-cost, have long cycle-life, have low self-discharge, be capable of operating at extreme temperatures, and, finally, should have high specific energy and high specific power. Emerging smart grid applications to improve energy efficiency require high power, long life, and lower cost for continued growth in the market place.

Automobile manufacturers have encountered substantial consumer resistance in launching fleets of electric and hybrid-electric vehicles due to the increased cost of these vehicles relative to conventional automobiles powered by an internal combustion engine (“ICE”). Environmental and energy independence concerns have exerted greater pressures on manufacturers to offer cost-effective alternatives to internal combustion engine-powered vehicles. Although electric and hybrid-electric vehicles can meet that demand, they typically rely on subsidies to defray the higher cost of the energy storage systems.

The definitions of various types of electric and hybrid-electric vehicles are not standardized. Among the more significant market segments that are generally recognized are “stop-start” micro-hybrid electric vehicles, mild-hybrid electric vehicles, strong-hybrid electric vehicles, and plug-in hybrid electric vehicles. Table 2 below compares the application of various battery electro-chemistries and the internal combustion engine (ICE) and their current roles in certain automotive applications. As used in Table 2, “Pb-Acid” means lead-acid, “SLI” means starting, lighting, ignition; “HEV” means hybrid-electric vehicle; “PHEV” means plug-in hybrid-electric vehicle; “EREV” means extended range electric vehicle; and “EV” means electric vehicle.

TABLE 2

| | | | Power | | Mild | | | | |
|---|---|---|---|---|---|---|---|---|---|
| | SLI | Start/Stop | Assist | Regeneration | Hybrid | HEV | PHEV | EREV | EV |
| Pb- | ✓ | | | | | | | | |
| Acid | | | | | | | | | |
| Ni- | | | ✓ | ✓ | ✓ | ✓ | | | |
| MH | | | | | | | | | |
| Li- | | | ✓ | ✓ | ✓ | ✓ | ✓ | ✓ | ✓ |
| ion | | | | | | | | | |
| ICE | ✓ | ✓ | ✓ | ✓ | ✓ | ✓ | ✓ | ✓ | |

As shown in Table 2, there remains a need for specific applications in which partial electrification of the vehicle may provide environmental and energy efficiency advantages, without the same level of added costs associated with hybrid and electric vehicles using Ni-MH and Li-ion batteries. Even more specifically, there is a need for a low cost, energy efficient battery in the area of start/stop automotive applications.

Specific points in the duty cycle of an internal combustion engine entail far greater inefficiency than others. Internal combustion engines operate efficiently only over a relatively narrow range of crankshaft speeds. For example, when the vehicle is idling at a stop, fuel is being consumed with no useful motive work being done. Idle vehicle running time, stop/start events, power steering, air conditioning, or other power electronics component operation entail substantial inefficiencies in terms of fuel economy, as do rapid acceleration events. In addition, environmental pollution from a vehicle at these stopped, “start-stop,” and rapid acceleration conditions is far worse than from a vehicle in which the internal combustion engine is operating at a fuel-efficient crankshaft speed. The partial electrification of the vehicle in relation to these more extreme operating conditions has been termed a “micro” or “mild” hybrid application, including start/stop electrification. Micro- and mild-hybrid technologies are unable to displace as much of the power delivered by the internal combustion engine as a full electric or hybrid-electric vehicle. Nonetheless, they may be able to increase fuel efficiency substantially in a cost-effective manner without the substantial capital expenditure associated with full electric or hybrid-electric vehicle applications.

Conventional lead-acid batteries have not yet been able to satisfy this need. Conventional lead-acid batteries have been designed and optimized specifically for SLI operation. The needs of a mild hybrid application are different. A new process, design, and production process need to be developed and optimized for the mild hybrid application.

One need for a mild hybrid application is for a low-weight battery. Conventional lead-acid batteries are relatively heavy. This causes the battery to have a low specific energy due to the substantial weight of the lead components and other structural components that are necessary to provide rigidity to the plates. SLI lead-acid batteries typically have thinner plates, providing increased surface area needed to produce the power necessary to start the engine. But the grid thickness is limited to a minimum useful thickness because of the casting process and the mechanics of the grid hang. The positive electrode is preferably thick enough to account for corrosion. Specifically, even if some of the grid material is oxidized, sufficient grid material remains to provide effective current collection. Conventional positive plates are rarely less than 0.08″ (main outside framing wires) and 0.05″ on the face wires because of the difficulties of casting at production rates and, more importantly, concern over poor cycle-life issues. These parameters limit power. Lead-acid batteries designed for deeper discharge applications (such as motive power for forklifts) typically have heavier plates to enable them to withstand the deeper depth of discharge in these applications.

Another need for a mild hybrid application is that rechargeable batteries should be able to be charged and discharged with less than 0.001% energy loss at each cycle. This is a function of the internal resistance of the design and the overvoltage necessary to overcome it. The reaction preferably is energy-efficient and involves minimal physical changes to the battery that might limit cycle-life. Side chemical reactions that may deteriorate the cell components, cause loss of life, create gaseous byproducts, or cause loss of energy are preferably minimal or absent. In addition, a rechargeable battery desirably has high specific energy, low resistance, and good performance over a wide range of temperatures and is able to mitigate the structural stresses caused by lattice expansion. When the design is optimized for minimum resistance, the charge and discharge efficiency will dramatically improve.

Lead-acid batteries have many of these characteristics. The charge-discharge process is essentially highly reversible. The lead-acid system has been extensively studied and the secondary chemical reactions have been identified. And their detrimental effects have been mitigated using catalyst materials or engineering approaches. Although its energy density and specific energy are relatively low, the lead-acid battery performs reliably over a wide range of temperatures, with good performance and good cycle life. A primary advantage of lead-acid batteries remains their low-cost.

A number of trade-offs must be considered in optimizing lead-acid batteries for various standby power and transportation uses. High-power density requires that the internal resistance of the battery be minimal. High-power and energy densities also require the plates and separators be porous and, typically, that the paste density also be very low. High cycle life, in contrast, requires premium separators, high paste density, and the presence of binders, modest depth of discharge, good maintenance, and the presence of alloying elements and thick positive plates. Low-cost, in further contrast, requires both minimum fixed and variable costs, high-speed automated processing, and that no premium materials be used for the grid, paste, separator, or other cell and battery components. Some of these goals are antagonistic and may be inconsistent.

The United States Department of Energy (USDOE) has issued Corporate Average Fuel Efficiency (CAFE) guidelines for automotive fleets. Previously, SUVs and light trucks were excluded from the CAFE averages for motor vehicles. More recently, however, integrated guidelines have emerged specifying fuel efficiency standards for passenger vehicles, light trucks, and SUVs. These guidelines require an average fuel efficiency of 31.4 miles per gallon by 2016. See “EPA, Final Rulemaking to Establish Light-Duty Vehicle Greenhouse Gas Emission Standards and Corporate Average Fuel Economy Standards, Regulatory Impact Analysis,” EPA-420-R-10-009 (April 2010).

Anticipated improvements in internal combustion engine technology do not appear to be able to reach this goal. Similarly, the manufacturing capacity for pure electric and hybrid-electric vehicles does not appear sufficient to be able to reach this goal. Thus, it is anticipated that some combination of micro-hybrids or mild hybrids, in which electrochemical cells provide some of the power for either stop/start or certain acceleration applications, will be necessary in order to meet the CAFE standards.

Lead-acid battery systems may provide a reliable replacement for Li-ion or Ni-MH batteries in these applications, without the substantial safety concerns associated with Li-ion electrochemistry and the increased cost associated with both Li-ion and Ni-MH batteries.

Electric vehicles were in widespread use in the early 20th century (1900 to 1912). During this period, over 30,000 electric vehicles were introduced into the United States. The development of the electric starter motor, however, eliminated the dangers of hand-cranking and enabled the gas-powered internal combustion engine to prevail over electric-drive designs. The high cost of batteries relative to internal combustion engine technologies effectively precluded the development of electric and hybrid-electric vehicles during most of the balance of the 20th century.

In response to increasing fuel efficiency and environmental concerns, hybrid electric vehicles and electric vehicles were reintroduced into the American market in the 1990s. Most of these were powered by Ni-MH batteries, although lead-acid batteries and other advanced battery designs were also used. These Ni-MH batteries, however, suffered several disadvantages including limited range, slow charging, and high cost. Throughout the development of electric and hybrid-electric vehicles in the 20th and 21st Centuries, the high cost of the batteries has frustrated commercialization.

Most electric vehicles that have been introduced into the US market currently employ Li-ion batteries, including those made by BMW; BYD; Daimler Benz; Ford; Mitsubishi; Nissan; REVA; Tesla; and Think. Of the major developers of 21st Century electric vehicles, only Chrysler and REVA have employed lead-acid battery technology. Both, however, made small, lightweight, specialized hybrid vehicles and not full-sized passenger vehicles. Moreover, Chrysler recently sold its GEM unit.

Thus, Li-ion batteries have become the dominant technology for electric and hybrid-electric vehicles. Yet, the sophisticated electronic controls necessary to keep Li-ion cells within proper operational limits are expensive and cumbersome. Given the high charging and discharging rates of these Li-ion systems, passive cooling is typically not effective, requiring forced air or forced liquid cooling. This further increases the complexity, weight, and cost of the battery systems. Moreover, many advanced battery types, and, in particular, Li-ion present substantial toxicity and/or safety issues.

The design of batteries for electric and hybrid electric vehicles typically involves a trade-off between energy and power energy. As the capability to provide power over time, specific energy is typically measured in Watt-hours per kilogram. Specific power is typically measured in Watts per kilogram.

The power and energy requirements for a typical stop-start hybrid electrical vehicle are generally no more challenging than for a conventional SLI application. The specific power requirements can be in the range of 600 Watts per kilogram and the specific energy requirements in the range of 25 Watt-hours per kilogram. These limits can be met with conventional lead-acid battery technology. Nonetheless, use of conventional lead-acid battery technology to satisfy these requirements typically results in systems that have excessive weight. Moreover, systems for stop-start hybrid electric vehicles may be required to perform several hundred thousand cycles and deliver several megawatt hours of total energy. These requirements are difficult for conventional lead-acid batteries to achieve in practice. Thus, although the specific power and specific energy requirements of stop-start hybrid electrical vehicles are within the theoretical range of conventional lead-acid battery technology, practical requirements have precluded the use of lead-acid batteries in this application. Instead, Li-ion batteries are typically required to meet these requirements. See, e.g., Reddy, Thomas D., ed., Linden's Handbook of Batteries, at 29-30, McGraw-Hill, New York, N.Y. (4th ed. 2011).

A number of improvements have been made in the basic design of lead-acid electrochemical cells. Many of these have involved improvements in the characteristics of the substrate, the active material, as well as the bus bars or collector elements. For example, a variety of fibers or metals have been added to or embedded in the substrate material to help strengthen it. The active material has been strengthened with a variety of materials, including synthetic fibers and other additions. Particularly with respect to lead-acid batteries, these various approaches represent a trade-off between durability, capacity, and specific energy. The addition of various non-conductive strengthening elements helps strengthen the supporting grid but replaces conductive substrate and active material with non-conductive components.

In order to reduce the weight of the lead-acid electrochemical cells relative to their specific energy, various improvements have been disclosed. One approach has been to coat a light-weight, high-tensile strength fiber with sufficient lead to make a composite wire that could be used to support the grid of the electrode. Robertson, U.S. Pat. No. 275,859 discloses an apparatus for extrusion of lead onto a core material for use as a telegraph cable. Barnes, U.S. Pat. No. 3,808,040 discloses strengthening a conductive latticework to serve as a grid element by depositing strips of synthetic resin. Specifically, Barnes '040 patent discloses a lead-coated glass fiber. These approaches, however, have been unable to produce a material with sufficient properties of high-corrosion resistance and high-tensile strength to be able to fabricate a commercially viable lead-acid battery that can survive chemical attack from the electrolyte.

Blayner, et al., have disclosed further improvements in the composition of the substrate to reduce the weight of the electrodes and to increase the proportion of conductive material. Blayner, U.S. Pat. Nos. 5,010,637 and 4,658,623. Blayner discloses a method and apparatus for coating a fiber with an extruded, corrosion-resistant metal. Blayner discloses a variety of core materials that can include high-tensile strength fibrous material, such as an optical glass fiber, or highly-conductive metal wire. Similarly, Blayner discloses that the extruded, corrosion-resistant metal can be any of a number of metals such as lead, zinc, or nickel.

Blayner discloses that a corrosion-resistant metal is extruded through die. The core material is drawn through the die as the metal is extruded onto the core material. Continuous lengths of metal wire or fiber are coated with a uniform layer of extruded, corrosion-resistant metal. The wire is then used to weave a screen that acts as a substrate for the active material. There are no fusion points at the intersections of the woven wires. Electrodes may be constructed using such a screen as a grid with the active material being applied onto the grid. Rechargeable lead-acid electrochemical cells are constructed using pairs of electrodes.

Blayner discloses further improvements regarding the grain structure of the metal coating on the core material. In particular, Blayner discloses that the extruded corrosion-resistant metal has a longitudinally-oriented grain structure and uniform grain size. U.S. Pat. Nos. 5,925,470 and 6,027,822.

Fang, et al., disclose in their paper, Effect of Gap Size on Coating Extrusion of Pb-GF Composite Wire by Theoretical Calculation and Experimental Investigation, J. Mater. Sci. Technol., Vol. 21, No. 5 (2005), optimizing the gap in extruding lead-coated glass fiber. Although Blayner does not disclose the relationship between gap size and extrusion of the lead coated composite wire, Fang characterizes gap size as a key parameter for the continuous coating extrusion process. Fang reports that a gap between 0.12 mm and 0.24 mm is necessary, with a gap of 0.18 mm being optimal. Fang further reports that continuous fiber composite wire can enhance load and improve energy utilization.

Jay, The Horizon Valve Regulated Lead Acid Battery-Reengineering the Lead-Acid Battery, IEE (1996) discloses details of the Horizon® advanced lead-acid battery. Using composite lead-fiberglass wires instead of traditional substrate materials, Jay discloses lead-acid batteries having specific power of 250 W/kg and specific energy of 50 Whr/kg. Yet, Jay reports further that these lead-acid batteries exhibited a one-hour cycle life of only 400 cycles at 100% depth of discharge. Extreme power advertises 4 kWhr specific energy and 10 kW specific power based on the Horizon lead-fiberglass composite design.

It has been reported that the Horizon battery was tested for electric vehicle use in a Chrysler T-Van. Horizon reports that the Horizon battery delivered a specific energy of 44 Wh/Kg, and a specific power of 300 W/Kg, for 280 Dynamic Stress Test (DST) cycles. The DST Test is specified by the U.S. Advanced Battery Consortium (USABC) to simulate typical urban driving profiles. In this DST test, the module is charges and discharged at various power levels so that the system will draw enough current (and cause differing amount of cell voltage) to sustain the specified power load. The module is cycled for a fixed number of cycles or until limits on temperature, voltage, current or step time or number of cycles are reached. A summary of a DST test is reported in Table3. See Eleventh Annual Battery Conference on Applications and Advances, (1996) at 159-162, IEEE digital identifier: 10.1109/BCAA.1996.484987, the entire contents of which are incorporated herein by reference.

TABLE 3
Dynamic Stress Test (DST) Schedule Adapted
From USABC (based on 15 kW base power)

| | | Discharge | Calculated | |
|---|---|---|---|---|
| Step # | Duration | power (%) | Power (kW) | |
| 1 | 16 | 0 | 0 | |
| 2 | 28 | −12.5 | 1.88 | dis |
| 3 | 12 | −25 | 3.75 | dis |
| 4 | 8 | 12.5 | 1.88 | chg |
| 5 | 16 | 0 | 0 | |
| 6 | 24 | −12.5 | 1.88 | dis |
| 7 | 12 | −25 | 3.75 | dis |
| 8 | 8 | 12.5 | 1.88 | chg |
| 9 | 16 | 0 | 0 | |
| 10 | 24 | −12.5 | 12.5 | dis |
| 11 | 12 | −25 | 3.75 | dis |
| 12 | 8 | 12.5 | 1.88 | chg |
| 13 | 16 | 0 | 0 | |
| 14 | 36 | −12.5 | 1.88 | dis |
| 15 | 8 | −100 | 15 | dis |
| 16 | 24 | −62.5 | 9.38 | dis |
| 17 | 8 | 25 | 3.75 | chg |
| 18 | 32 | −25 | 3.75 | dis |
| 19 | 8 | 50 | 7.5 | chg |

| | | | |
|---|---|---|---|
| 20 | 44 | 0 | 0 |

A Peukert curve, such as the one shown in FIG. 4, characterizes the performance of a design over a full range of conditions. It is based on repeatedly discharging cells, typically at a 3-5 set rate (Amp.) condition, at different C (capacity) rates, for example, C/10, C/6, 1C, 10C, and 20C. Measured Ampere-hour capacities are used to calculate a Peukert constant. Performance at other discharge rates are predicted based on the Peukert equation:

Cₚ=I^{k}t

where C=capacity, I=discharge current, t=discharge time, and k is the constant determined from the measurements.

Peukert's law can be written as:

$$It = {C ( \frac{C}{IH} )}^{k - 1}$$

where “It” is the effective capacity at the discharge rate I down to a point where cell voltage falls rapidly. Where the capacity is listed for two discharge rates, the Peukert exponent can be determined algebraically. For higher C-rates the end voltages change to compensate for the IR voltage loss. Specifically, as the rate goes up the cut off voltage go down. For example, for every 5C beyond 1C, the cell voltage cut off falls by about 200 my. Power is determined at the midpoint voltage for high rate discharge. These powers are also determined at different states of charge 100%, 80%, 60%, 40%, and 30%, for both discharge and charge. The immediate charge/discharge history may affect these values, as does temperature.

The present inventors have found that, despite improvements in lead-acid electrochemical cells for automotive applications, prior known lead-acid batteries have not been able to achieve the same performance as Li-ion or Ni-MH cells for similar applications. There remains a need, therefore, for further improvements in the design and composition of lead-acid electrochemical cells to meet the specialized needs of the automotive and stand-by power markets. Specifically, there remains a need for a reliable replacement for lithium-ion electrochemical cells in certain applications that do not entail the same safety concerns raised by Li-ion electrochemical cells. Similarly, there remains a need for a reliable replacement for Ni-MH and Li-ion electrochemical cells with the added benefits of low-cost and reliability of lead-acid electrochemical cells. In addition, there remains a need for substantial improvement in battery production capacity to meet the growing needs of the automotive and stand-by power segments.

### SUMMARY

The present disclosure includes a lead-acid battery having higher specific power and specific energy than prior known lead-acid batteries. An lead-acid electrochemical storage device is provided, comprising a specific power of between about 550 and about 1,750 Watts/kilogram; and a specific energy of between about 25 and about 80 Watt-hours/kilogram. The device, preferably, has a cycle life of greater than 150 cycles and is adapted for use in a vehicle application. The application preferably comprises of stop/start or the partial or complete electrification of the vehicle propulsion system. The device preferably has a bipolar or pseudo-bipolar design, multiple cells disposed within a common casing, and the cells are connected ionically within each cell and electronically between cells.

Additional objects and advantages of the disclosure will be set forth in part in the description which follows, and in part will be apparent from the description, or may be learned by practice of the disclosure. The objects and advantages of the disclosure will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one embodiments of the disclosure and together with the description, serve to explain the principles of the disclosure.

### BRIEF DESCRIPTION OF THE DRAWINGS

FIG. 1 shows a Ragone plot of the range of specific power and specific energy of various prior known energy storage systems and an internal combustion engine.

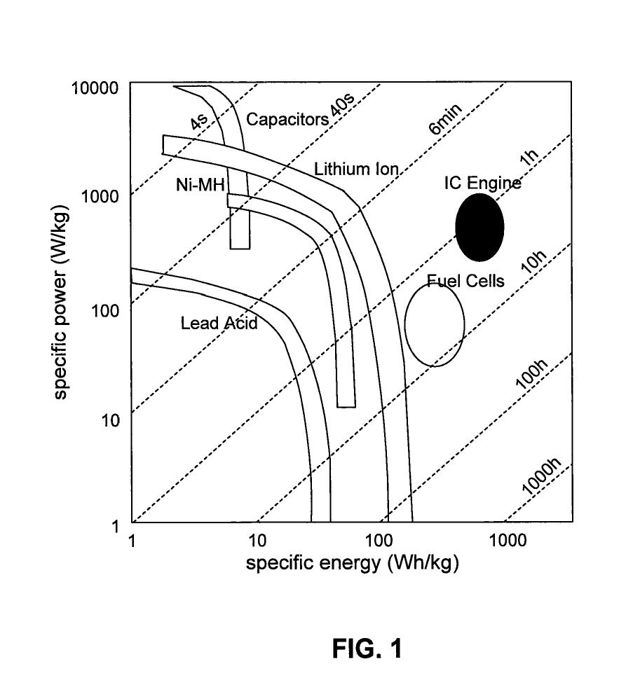

FIG. 2 is a Ragone plot of the range of specific power and specific energy of various prior known energy storage systems, an internal combustion engine, and certain embodiments of the present disclosure.

FIG. 3 is a graph of cell voltage as a function of current.

FIG. 4 is a Peukert Curve of the discharge characteristics of an embodiment of the present disclosure.

FIG. 5 is a schematic diagram of the change in aspect ratio of electrodes of an embodiment of the present disclosure.

FIG. 6 is a schematic diagram of a bus bar of an embodiment of the present disclosure.

FIG. 7 is a schematic diagram depicting the copper scallops of an embodiment of the present disclosure.

FIG. 8 is a schematic diagram of a mono-directional grid substrate of an embodiment of the present disclosure.

FIG. 9 is a schematic isometric view of a portion of a lead-acid electrochemical cell with a plurality of electrode assemblies in a stacked configuration according to another embodiment of the present disclosure.

FIG. 10 is a schematic isometric view of the lead-acid electrochemical cell of FIG. 9 connected to a power bus.

FIG. 11 is an exploded isometric view of the power bus of FIG. 10.

FIG. 12 is an exploded isometric view of a partial lead-acid electrochemical cell module, power bus, and package according to another embodiment of the present disclosure.

FIG. 13A is an isometric view of a partial lead-acid electrochemical cell module, power bus, and package according to another embodiment of the present disclosure.

FIG. 13B is a side view of a portion of the partial cell depicted in FIG. 13A.

### DETAILED DESCRIPTION

Reference will now be made in detail to exemplary embodiments of the present disclosure, examples of which are illustrated in the accompanying drawings. Wherever possible, the same reference numbers will be used throughout the drawings to refer to the same or like parts.

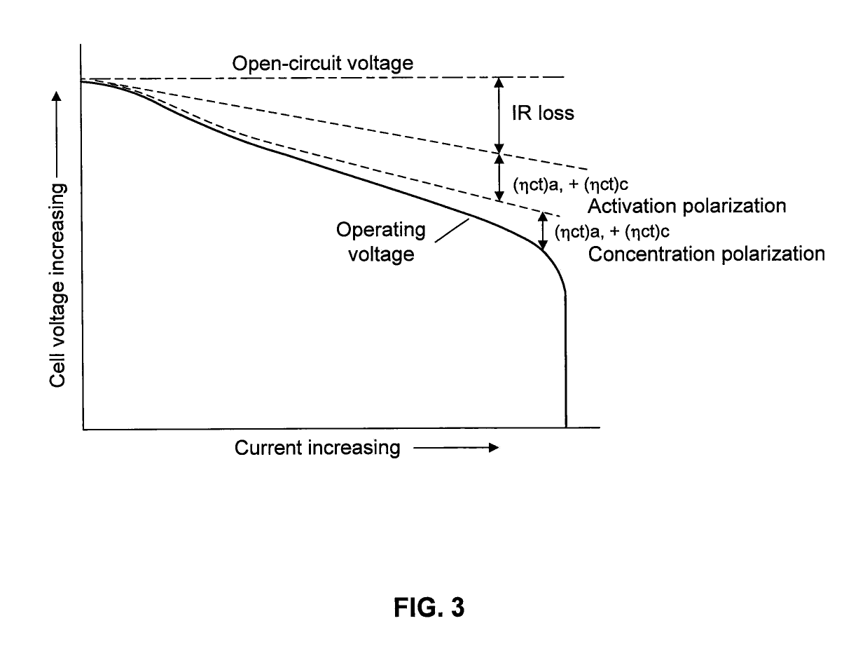

Various embodiments of the present disclosure achieved substantial improvements in the specific power and/or specific energy of Pb-acid (lead-acid) batteries by reducing the internal resistance of the electrochemical cell. Specifically, as depicted in FIG. 3, resistance is primarily a function of three factors: activation; internal resistance; and mass transport. See Reddy, Thomas D., ed., LINDEN'S HANDBOOK OF BATTERIES, at 2.2-2.3, McGraw-Hill, New York, N.Y. (4^{th} ed. 2011). In particular, FIG. 3 depicts the relative influence of several factors, including internal resistance (“IR loss”), activation (“activation polarization”), and mass transport (“concentration polarization”) that effect power in a typical lead-acid battery.

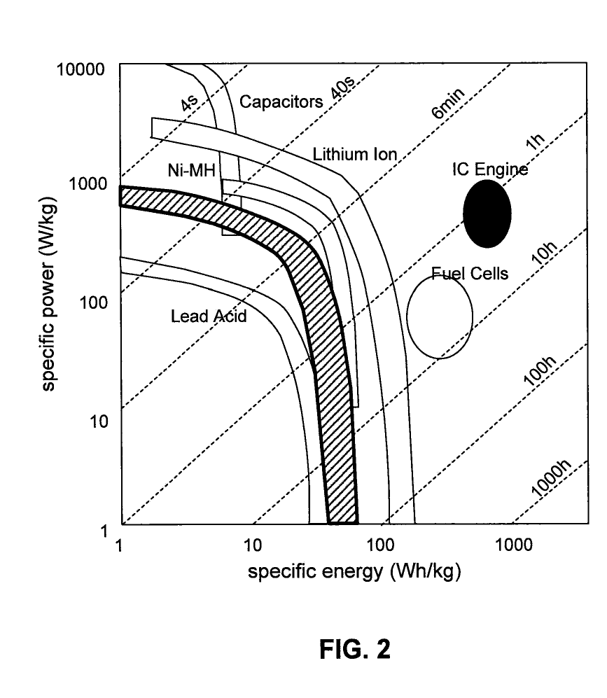

The internal resistance of the Pb-acid electrochemical cell is, in turn, a function of several additional factors, which include grid, grid-to-end terminal connections, inter-terminal connections, and end-terminal connections. Specifically, by reducing the resistance of these components, various embodiments have been able to create Pb-acid electrochemical cells and batteries with improved specific power and specific energy relative to prior known Pb-acid electrochemical cells and batteries. In particular, various advances that have contributed to improved specific power and specific energy, in accordance to this disclosure, include end plate connection, bus bar, and aspect ratio of plates. By making these improvements, embodiments of electrochemical cells of the present disclosure have achieved specific powers exceeding 855 W/kg, which are well in excess of the 525 W/kg specific power of a benchmark Pb-acid electrochemical cell. Embodiments of the present disclosure have achieved improved results as shown by the cross-hatched area on FIG. 2, well in excess of prior know Pb-acid designs.

In addition, the improvements of the present disclosure provide a lead-acid battery that offers cycle life suitable for use in vehicle applications. Specifically, for vehicle use, lead acid batteries must maintain good performance over repeated cycles. In various embodiments, a minimum requirement would be around 150 cycles. Preferably, lead-acid cells of various embodiments would maintain good performance characteristics over thousands of cycles.

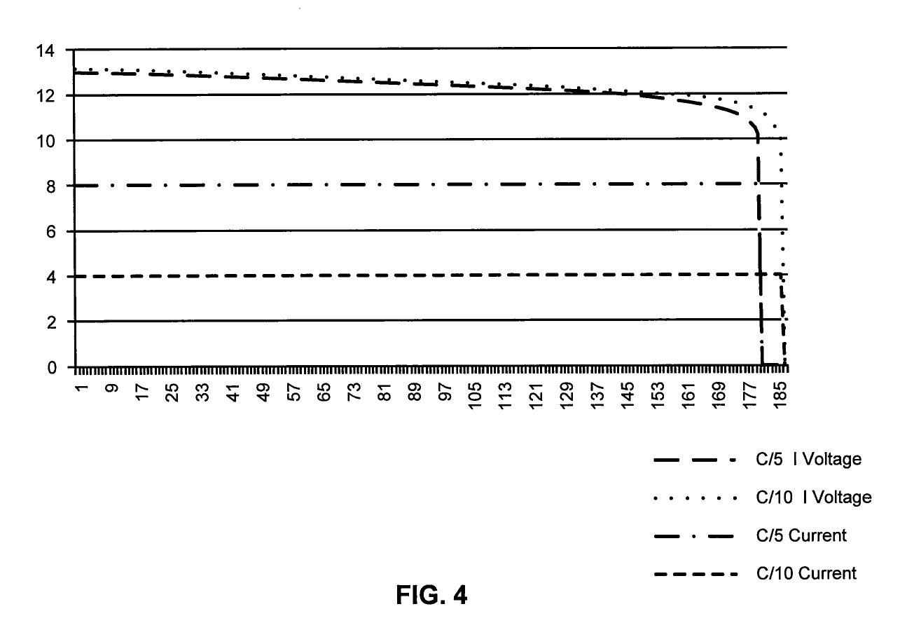

In order to ensure valid comparisons of the performance of different batteries, power and energy should be measured in a standardized way. For electric and hybrid-electric vehicle batteries, in accordance with some embodiments, power is measured in 2 second pulses at 100% and 80% depth of discharge, and at 10 second pulses at 100% and 80% depth of discharge. The “benchmark” cell described below is a conventional cell of the type known prior to the present disclosure. FIG. 4 depicts a Peukert Curve, which along with the accompanying discussion, above, illustrates one method of calculating power in accordance with some embodiments. In particular, FIG. 4 shows the changes in voltage and in current at various discharge rates, namely, C/5 ad C/10, showing the voltage and current obtained at these rates. The x-axis in FIG. 4 depicts time in arbitrary units of time. The y-axis depicts both voltage in Volts and current in Amps. The uppermost two curves depict voltage at C/5 and C/10 discharge rates and the lower two curves depict the respective currents of 8 A (C/5) and 4A (C/10) discharge rates.

### Example 1

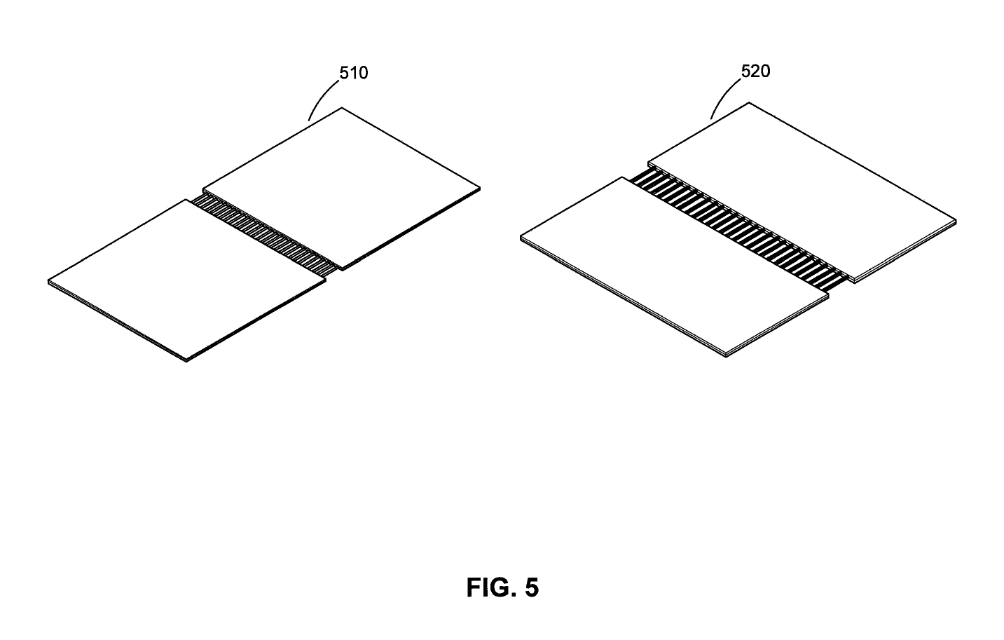

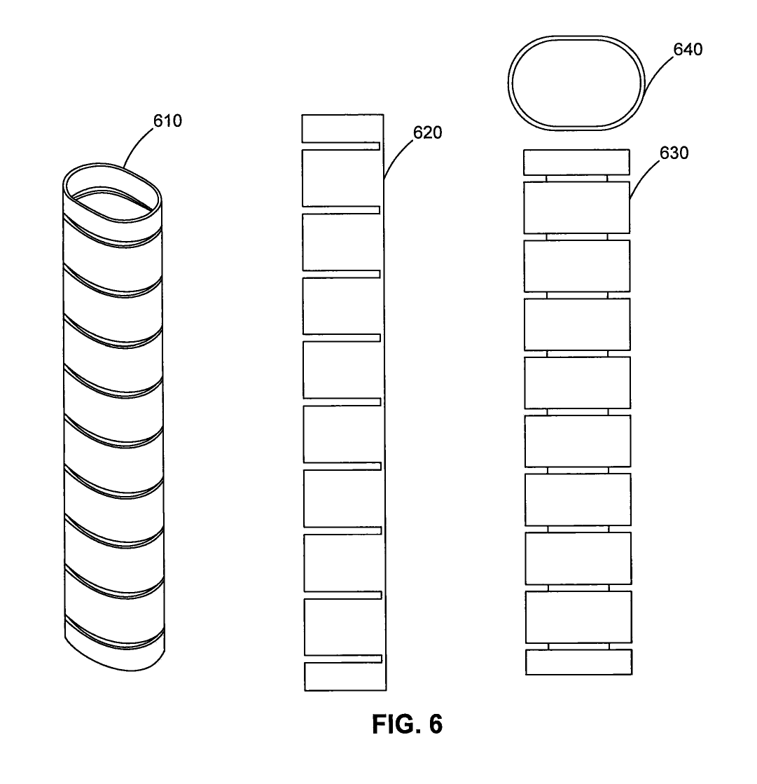

Several improvements were made over the benchmark design in accordance with some embodiments presented under Example 1 and shown in FIGS. 5 and 6.

First, according to some embodiments, the aspect ratio of the electrode plates was modified. FIG. 5 illustrates such a change in accordance with an embodiment. FIG. 5 shows electrode plates 510 and 520. Electrode plate 510 is a 4″ by 4″ electrode plate, while electrode plate 520 is a 2″ by 4″ electrode plate. In accordance to various embodiments, such a modification of the aspect ratio of the electrode plates enables more efficient current collection.

Second, the material of the bus bar was modified in accordance with some embodiments. The benchmark design employed cast lead end plates as a bus bar. The embodiment of Example 1 shown in FIG. 6, on the other hand, employed a bus bar 600 made of copper tube. In the embodiment shown in FIG. 6, copper tube 600 has a plurality of slits 610 formed therein. Each slit 610 extends part-way through copper tube 600 to receive the end caps of the electrode plate and to retain the electrode plates.

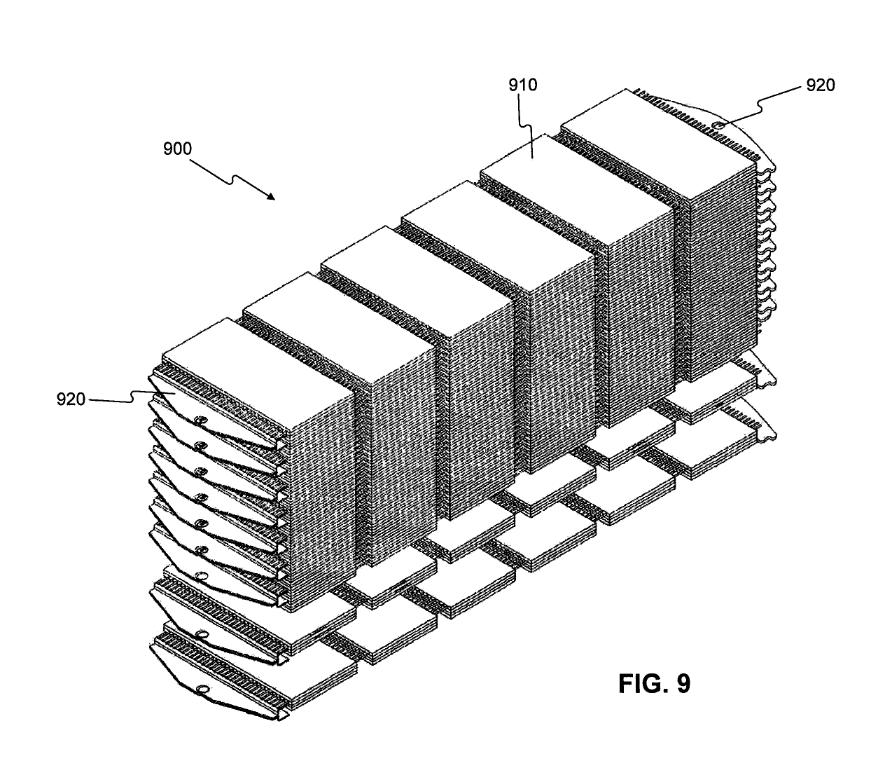

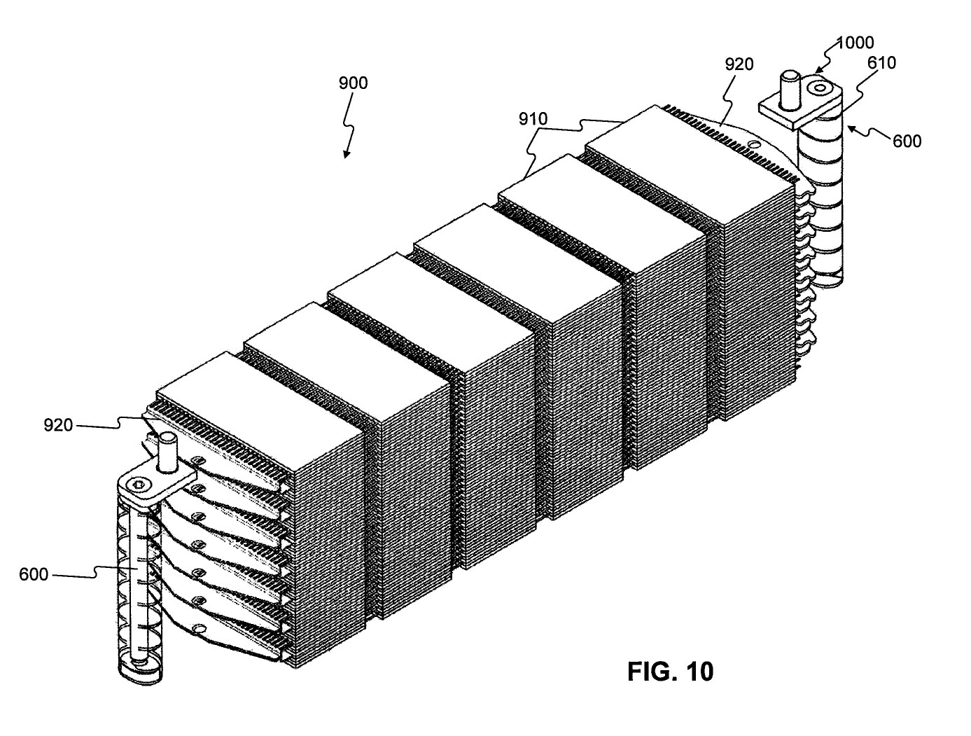

FIGS. 9 and 10 show oblique views a plate assembly 900 of electrode plates 910 according to some embodiments. The assemblies of electrode plates 910 include end caps 920. As shown in FIG. 10, end caps 920 are retained within the slits 610 in bus bar 600, which is part of a bus bar assembly 1000.

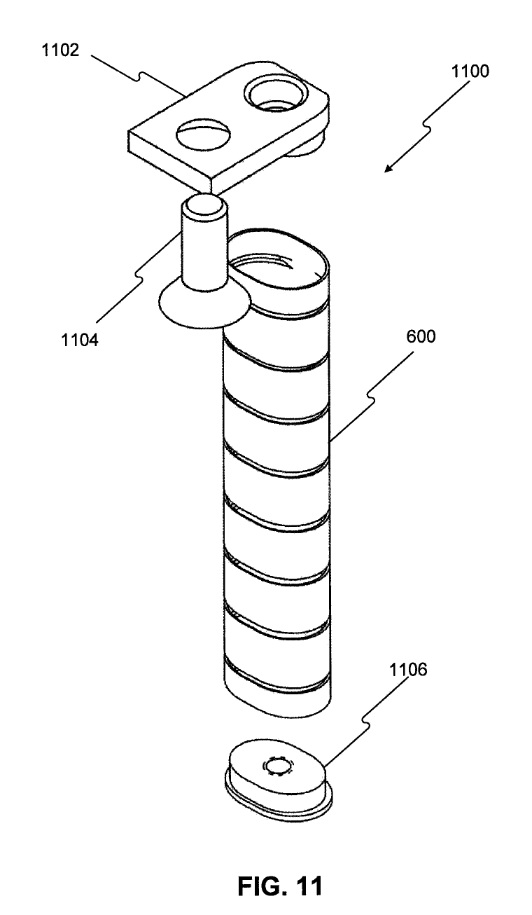

FIG. 11 depicts an exploded view of a bus bar assembly 1100, according to various embodiments. Bus bar assembly 1100 includes a bus bar 600, a connector piece 1102, a terminal 1104, and a nut 1106.

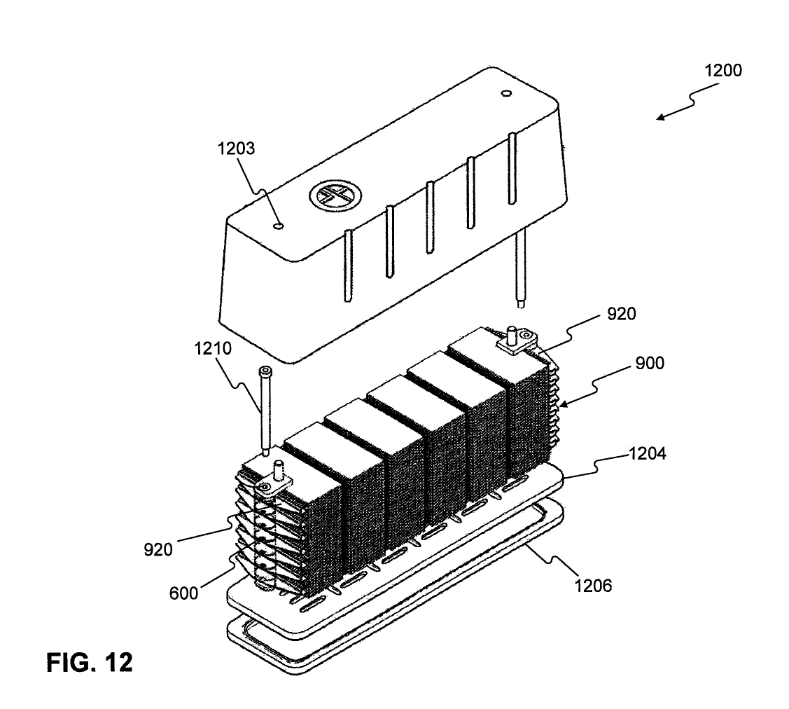

FIG. 12 illustrates a lead-acid electrochemical cell module 1200 including plate assembly 900 according to some embodiments. The lead-acid electrochemical cell module 1200 may include a casing 1203, a slotted tray 1204, a drip tray 1206, and a bolt 1210. In particular, FIG. 12 shows end caps 920 retained within the slits of bus bar 600. Further, bolt 1210 passes through the aligned holes of end caps 920 and the cavity inside bus bar 600.

Various embodiments of Example 1 achieve a specific power of 855 W/kg for the battery. This specific power is well in excess of that of prior known designs and well in excess of the benchmark design, for which the specific power is around 535 W/kg. Such improvement results in significant savings in, for example, the weight of the battery. For a battery of Example 1 delivering 50 kW for 2 seconds and 855 W/kg, the savings in weight is substantial. Such a battery would weigh about 58.5 kg (50,000 W/855 W/kg=58.5 kg). The battery of Example 1 delivers 1,200 Whr or 1.2 kWhr. In contrast, a benchmark battery delivering 535 W/kg weighs about 93.5 kg. A 40 Wh benchmark battery delivers 3,740 Whr, or 3.8 kWhr. Thus, the benchmark battery is about 1.5 times the weight of the battery of Example 1. Table 5 compares various characteristics of the batteries of the embodiments of Example 1 with those of the benchmark battery. The calculations of Table 5, as well as those in Tables 6 and 7 below, assume that module impedance remains constant in the “Normalized” module.

TABLE 5
Comparison of Embodiment of Example 1 with Benchmark Design

| | | | | | Example 1 | |
|---|---|---|---|---|---|---|
| | | | | | Normalized to | |
| | Benchmark Design | | Example 1 | | Benchmark Design | |
| Voltage | 12 | V | 12 | V | 12 | V |
| A hr | 85 | Ahr | 40 | Ahr | 85 | Ahr |
| Grid weight per | 43.0 | g | 21.5 | g | — | |
| plate | | | | | | |
| Grid | Standard Lead Wire | | Standard Lead Wire | | — | |
| | Grid | | Grid | | | |
| Negative | 0.0606″ | | 0.068″ | | — | |
| Thickness | | | | | | |
| Positive | 0.0846″ | | 0.088″ | | — | |
| Thickness | | | | | | |
| Separator | 0.059″ | | 0.060″ | | — | |
| Thickness | | | | | | |
| Pasting paper | 0.005″ × 2 | | 0.005″ × 2 | | — | |
| thickness | | | | | | |
| No. of Paired | 134 | | 96 | | 204 | |
| Electrodes | | | | | | |
| Paste | Tribasic | | Layered Tribasic | | — | |
| Specific Objective | 27,244.8 | cm2 | 9,700.8 | cm2 | 20,612.9 | cm² |
| Surface Area-- | | | | | | |
| contact surface | | | | | | |
| area of separator | | | | | | |
| between plates | | | | | | |
| Plate weight | 4,128 | g | 2,064 | g (2 kg) | 4,386 | g |
| Termination | Lead end plate with | | Copper tube with | | — | |
| | soldered lead wires | | slits for securing | | | |
| | with cast lead | | ends of plates with | | | |
| | terminal end | | end plates crimped | | | |
| | | | into slit in copper | | | |
| | | | pipe; lead-clad | | | |
| | | | copper rod ( 3/16″) | | | |
| | | | (10 gauge −0.180″) | | | |
| | | | running down each | | | |
| | | | face of end plates | | | |
| Module | 2.7 | mΩ | 5.4 | mΩ | — | |
| Impedance | | | | | | |
| Specific Power | 525 | W/kg | 855 | W/kg | 855 | W/kg* |

According to various embodiments, to increase the specific power the electrodes may be made thinner to improve activation and mass transport. Moreover, according to some embodiments, more electrodes may be disposed in the same volume, further improving mass transport. Further, in accordance with some embodiments, improvements in the paste contribute to reducing ohmic resistance. Specifically, Solka-Floc microfiber material may be added to the paste to reduce shrinkage and increase BET (Braun Emmett Teller) surface area (measured by ASTM Standard # C1274-10). The improved paste composition may improve mass transport. In addition, the fiber dissolves in contact with the electrolyte (forming CO2 and H2O) potentially leaving channels in the active material.

Further, according to various embodiments, improvements in the end plates, and bus bar connectors, discussed above, may further contribute to reducing the internal resistance and improving the mass transport of the improved electrochemical cell of the present disclosure.

### Example 2

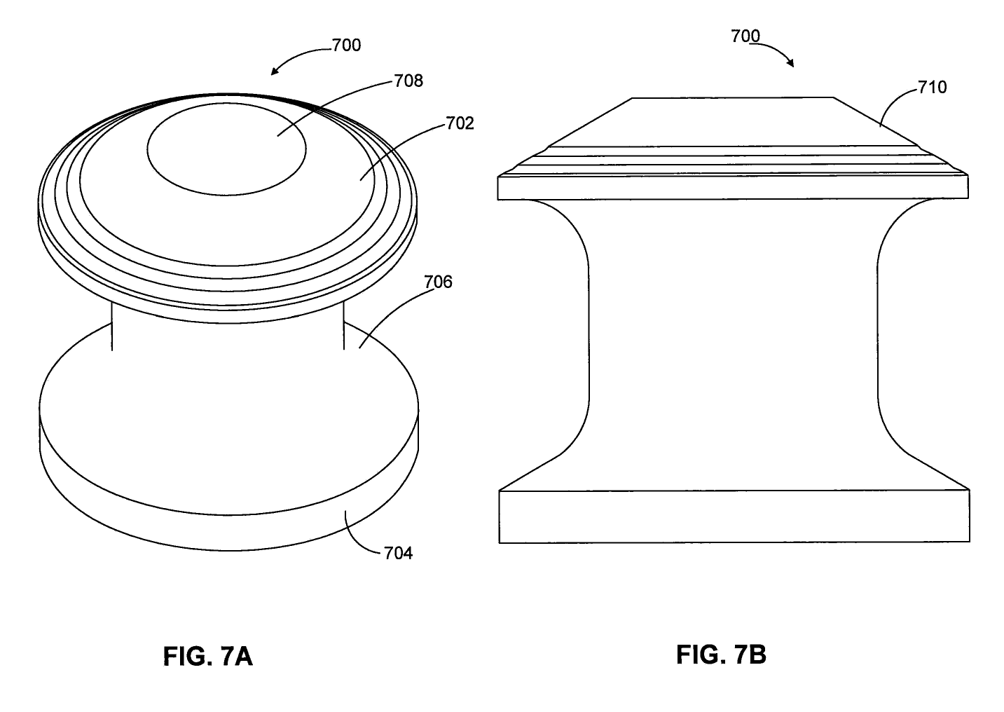

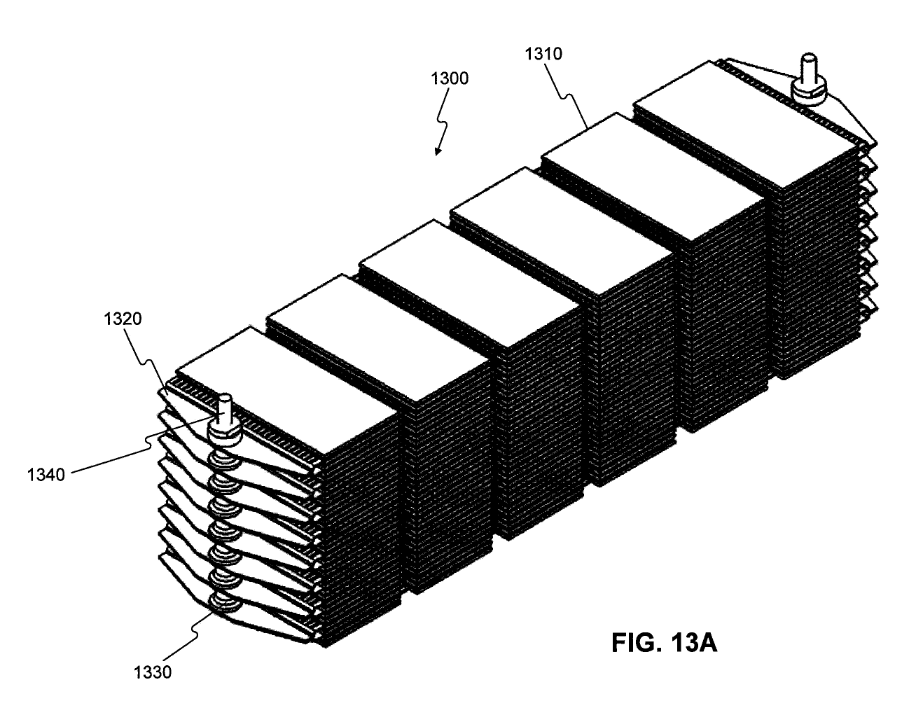

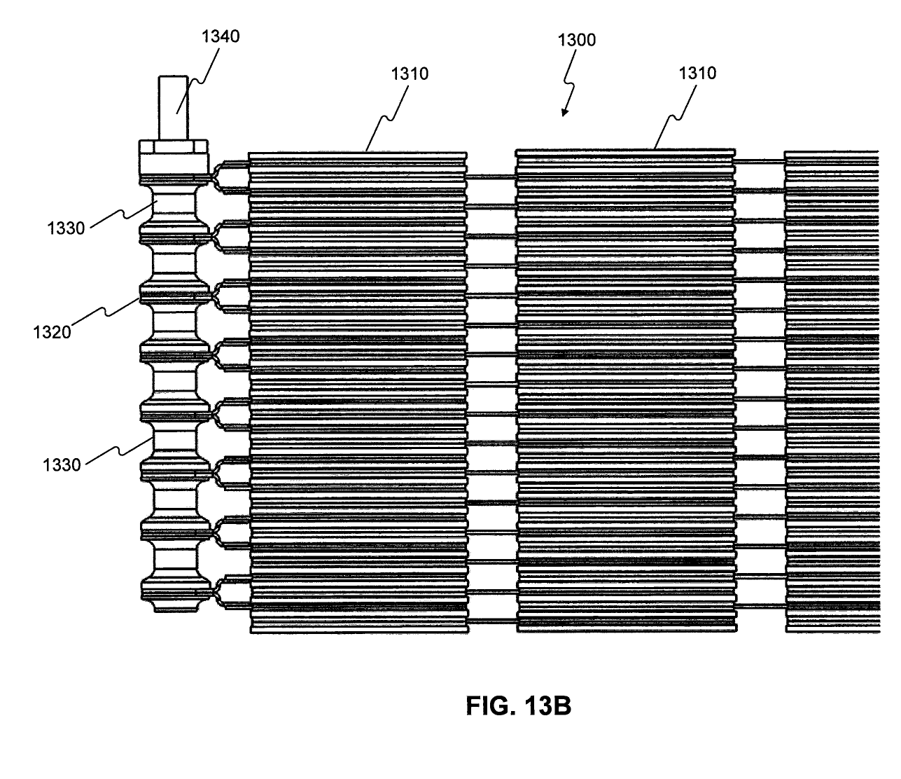

Several further improvements were made over the benchmark design in accordance with some embodiments presented under Example 2 and shown in FIG. 7. Various embodiment of Example 2 employed 2″×4″ electrode plates similar to those employed in the embodiments of Example 1. Instead of the copper tube bus bar, however, copper scallops, of the type shown in FIGS. 7A and 7B, were employed. FIGS. 7A and 7B show, from two different angles, a copper scallop 700, according to some embodiments. Moreover, FIGS. 13A and 13B show, from two different angles, a plate assembly 1300 using the scallops according to various embodiments.

Scallop 700 of FIG. 7 includes upper and lower ends 702 and 704 and a stem 706 connecting those ends. Further, an opening 708 is formed in the center of scallop 700 which provides a go through channel for a bolt, according to some embodiments. In some embodiments one or both of upper and lower ends 702 and 704 are shaped to include a slanted portion 710. In some embodiments, slanted portion 710 is shaped and sized to fit inside the opening in the end caps of electrode plates, as described in relation to FIGS. 13A and 13B.

Plate assembly 1300 of FIGS. 13A and 13B includes electrode plates 1310, end caps 1320, scallops 1330 and bolt 1340. Scallops 1330 are positioned between end caps 1320 and secured in a stack to retain the end caps. In some embodiments, in the assembly, the slanted portion of upper or lower end of each scallop 1330 is fit inside the opening of the corresponding end cap 1320 to secure the end cap in place. Further, in some embodiment, when assembled, the openings in end caps 1320 and scallops 1330 line up and form a channel for bolt 1340 to go through.

Table 6 compares various characteristics of the batteries of the embodiments of Example 2 with those of the benchmark design.

TABLE 6
Comparison of Embodiment of Example 2 with Benchmark Design

| | | | | | Example 2 | |
|---|---|---|---|---|---|---|
| | | | | | Normalized to | |
| | Benchmark Design | | Example 2 | | Benchmark | |
| Voltage | 12 | V | 12 | V | 12 | V |
| A hr | 85 | Ahr | 40 | Ahr | 85 | Ahr |
| Grid weight per | 43.0 | g | 20.7 | g | — | |
| plate | | | | | | |
| Grid | Standard Lead Wire | | Lead Wire Grid | | — | |
| | Grid | | | | | |
| Negative | 0.0606″ | | 0.068″ | | — | |
| Thickness | | | | | | |
| Positive | 0.0846″ | | 0.088″ | | — | |
| Thickness | | | | | | |
| Separator | 0.059″ | | 0.060″ | | — | |
| Thickness | | | | | | |
| Pasting paper | 0.005″ × 2 | | 0.005″ × 2 | | — | |
| thickness | | | | | | |
| No. of Paired | 134 | | 96 | | 204 | |
| Electrodes | | | | | | |
| Paste | Tribasic | | Layered Tribasic | | — | |
| Specific Objective | 27,244.8 | cm2 | 9,288.8 | cm2 | 19,738.7 | cm² |
| Surface Area-- | | | | | | |
| contact surface | | | | | | |
| area of separator | | | | | | |
| between plates | | | | | | |
| Plate weight | 4,128 | g | 2,064 | g (2 kg) | 4,386 | g |
| Termination | Lead end plate with | | Solid copper spacers | | — | |
| | soldered lead wires | | between end plates | | | |
| | with cast lead | | end plates have | | | |
| | terminal end | | welded edges of lead | | | |
| | | | end plates to reduce | | | |
| | | | resistance; lead-clad | | | |
| | | | copper rod ( 3/16″) | | | |
| | | | (10 gauge −0.180) | | | |
| | | | running down each | | | |
| | | | face of end plates | | | |
| Module Impedance | 2.7 | mΩ | 2.85 | mΩ | — | |
| Specific Power | 525 | W/kg | 940 | W/kg | 940 | W/kg |

Batteries made in accordance with the embodiments of Example 2 reach a specific power of 940 W/kg, well in excess of that of prior known designs and well in excess of the benchmark design. For a battery of Example 2 delivering 50 kW for 2 seconds, the improved battery weighs about 53 kg (50,000 W divided by 940 W/kg=53.2 kg). Prior known batteries, on the other hand and as shown above, weigh about 93.5 kg. Thus, the weight of the benchmark battery is about 2 times that of the battery of the embodiments of Example 2. Moreover, in the improved batteries of the embodiments of Example 2, a 40 Wh battery would deliver 2,128 Whr or 2.1 kWhr.

### Example 3

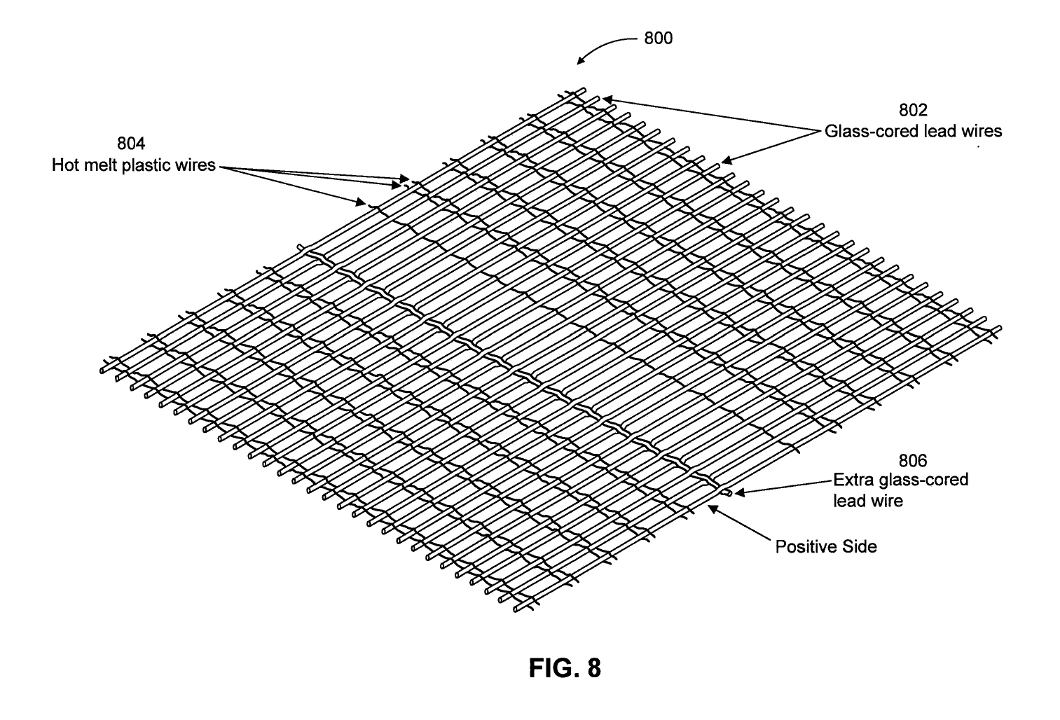

Further improvements were made over the benchmark design in accordance with some embodiments presented under Example 3 and shown in FIG. 8. In the embodiments of Example 3, the aspect ratio of the 2″×4″ electrode plates of Example 1 and scalloped copper bur bar of Example 2 were retained. The thickness of the electrodes and separator were further reduced in the manner listed in Table 7. Moreover, in the embodiments of Example 3 the grid was aligned in the current flow direction as depicted in FIG. 8 in accordance with some embodiments.

FIG. 8 is a schematic diagram of a mono-directional grid substrate of an embodiment of the present disclosure. FIG. 8 shows a grid 800, which includes glass-cored lead wires 802 and hot melt plastic wires 804 and 806. In FIG. 8, the directional substrate is oriented such that the glass-coated lead wires 802 run in the current flow direction, electrically connecting the positive and negative halves of the electrode plate. Specifically, the glass-cored lead wires 802 are oriented so that they run from plate to plate, electrically connecting the two plates. The grid serves as a substrate for the active material and as a current collector. These additional improvements resulted in substantially improved power.

Table 7 compares various characteristics of the batteries of the embodiments of Example 3 with those of the benchmark design.

TABLE 7
Comparison of Embodiment of Example 3 with Benchmark Design

| | | | | | Example 3 | |
|---|---|---|---|---|---|---|
| | | | Example 3 | | Normalized to | |
| | Benchmark Design | | Measured Values | | Benchmark | |
| Voltage | 12 | V | 4 | V | 12 | V |
| A hr | 85 | Ahr | 7 | Ahr | 85 | Ahr |
| Grid weight per | 43.0 | g | 15.5 | g | — | |
| plate | | | | | | |
| Grid | Standard Lead Wire | | Current Flow | | — | |
| | Grid | | Direction Grid | | | |
| Negative | 0.0606″ | | 0.046″ | | — | |
| Thickness | | | | | | |
| Positive | 0.0846″ | | 0.053″ | | — | |
| Thickness | | | | | | |
| Separator | 0.059″ | | 0.042″ | | — | |
| Thickness | | | | | | |
| Pasting paper | 0.005″ × 2 | | 0.005″ × 2 | | — | |
| thickness | | | | | | |
| No. of Paired | 134 | | 2 | | 24 | |
| Electrodes | | | | | | |
| Paste | Tribasic | | Layered Tribasic | | — | |
| Specific Objective | 27,244.8 | cm2 | 101.6 | cm2 | 1,233.4 | cm2 |
| Surface Area-- | | | | | | |
| contact surface | | | | | | |
| area of separator | | | | | | |
| between plates | | | | | | |
| Plate weight | 4,128 | g | 31 | g | 372 | g |

| Termination | Lead end plate with | | Solid copper spacers | | — |
|---|---|---|---|---|---|
| | soldered lead wires | | between end plates | | |
| | with cast lead | | end plates have | | |
| | terminal end | | welded edges of lead | | |
| | | | end plates to reduce | | |
| | | | resistance; lead-clad | | |
| | | | copper rod ( 3/16″) | | |
| | | | (10 gauge −0.180) | | |
| | | | running down each | | |
| | | | face of end plates | | |
| Module Impedance | 2.7 | mΩ | 3.16 | mΩ | — |
| Specific Power | 525 | W/kg | 1,809-1906 | W/kg | 1900 |

Although full cells were made employing the improvements of this further embodiment, they were smaller sized-cells (4 V and 7-8 Ahr). Test results on these smaller sized cells ranged from 1809 W/kg to 1906 W/kg. Nonetheless, the results of testing on these smaller cells indicates that full sized cells would produce results of about 1900 W/kg, well in excess of prior known designs and well in excess of the benchmark design.

Embodiments of the present disclosure are not limited to transportation and automotive applications. Embodiments of the present disclosure may be of use in any area known to those skilled in the art where use of lead-acid batteries is desired, such as stationary power uses and energy storage systems for back-up power situations. Further, the present inventors intend that the elements or components of the various embodiments disclosed herein may be used together with other elements or components of other embodiments.

Other embodiments of the disclosure will be apparent to those skilled in the art from consideration of the specification and practice of the invention disclosed herein. For example, various elements or components of the disclosed embodiments may be combined with other elements or components of other embodiments, as appropriate for the desired application. Thus, it is intended that the specification and examples be considered as exemplary only, with a true scope and spirit of the disclosure being indicated by the following claims.

What is claimed is:

1. A lead-acid electrochemical storage device, wherein the lead-acid electrochemical storage device has a specific power that is greater than or equal to about 550 Watts/kilogram and less than or equal to about 1,900 Watts/kilogram; and further wherein the lead-acid electrochemical storage device has a specific energy that is greater than or equal to about 25 Watt-hours/kilogram and less than or equal to about 80 Watt-hours/kilogram.

2. The device of claim 1, wherein the cycle life of the device is greater than or equal to about 150 cycles.

3. The device of claim 1, adapted for use in a vehicle application.

4. The device of claim 3, wherein the vehicle application is selected from the group consisting of stop/start, partial electrification, and complete electrification of a vehicle propulsion system.

5. The device of claim 1, wherein the device includes negative and positive electrodes sharing a common current collecting substrate and having a bipolar design or pseudo-bipolar design.

6. The device of claim 1, wherein the device comprises a plurality of cells.

7. The device of claim 1, wherein the device comprises a plurality of cells disposed within a common casing.

8. The device of claim 7, wherein the plurality of cells are connected ionically within each cell and electrically between cells.

9. An aqueous electrochemical storage device, operable between −30° and 80° C., wherein the storage device has a specific power of between about 1,500 Watts/kilogram and about 1,750 Watts/kilogram and a specific energy of between about 25 Watt-hours/kilogram and about 100 Watt-hours/kilogram.

10. The device of claim 9, wherein the device comprises a lead-acid battery module.

11. The device of claim 9, wherein the cycle life of the device is greater than or equal to 150 cycles.

12. The device of claim 11, wherein the device is adapted for use in a vehicle application.

13. The device of claim 12 wherein the vehicle application is selected from the group consisting of stop/start, partial electrification, and complete electrification of a vehicle propulsion system.

14. The device of claim 10, wherein the lead-acid battery module includes negative and positive electrodes sharing a common current collecting substrate and having a bipolar or pseudo-bipolar design.

15. A lead-acid electrochemical storage device comprising:
a plurality of electrode plates, wherein each of the plurality of electrode plates has a shape with a width and a length and wherein a ratio of the length to the width is about two; and
a bus bar comprising a plurality of slits for electrically connecting the plurality of electrode plates.

16. The storage device of claim 15, wherein each of the bus bar comprises copper.

17. The storage device of claim 16, wherein the bus bar comprises a copper tube.

18. The storage device of claim 15, wherein the width of each the plurality of electrode plate is about two inches and the length of each of the plurality of electrode plates is about four inches.

19. The storage device of claim 15, wherein each of the plurality of electrode plates includes an end cap configured for electrical connection with said bus bar.

20. The storage device of claim 15, wherein each of the plurality of electrode plates also has a thickness that is less than xxx.

21. The storage device of claim 15, wherein the plurality of electrode plates are electrically connected by a microfiber material with an ohmic resistance below.

22. A lead-acid electrochemical storage device comprising:
a plurality of electrode plates, wherein each of the plurality of electrode plates has a shape with a width and a length and wherein a ratio of the length to the width is about two; and
a bus bar comprising a plurality of copper scallops for electrically connecting a plurality of electrode plates.

23. The storage device of claim 22, wherein each of the plurality of electrode plates also has a thickness that is less than 0.1 inches.

24. The storage device of claim 22, further comprising a mono-directional grid.

25. The storage device of claim 15, wherein the device has a specific power that is greater than about 550 Watts/kilogram and further has a specific energy that is greater than about 25 Watt-hours/kilogram.
